(19) United States
(12) Patent Application Publication
(10) Pub. No.: US 2025/0034019 A1
(43) Pub. Date: Jan. 30, 2025

(54) AN ELECTROKINETIC METHOD AND SYSTEM FOR DEWATERING SOFT SOILS, SLURRIES, COLLOIDAL SUSPENSIONS AND OTHER DEPOSITS

(71) Applicant: ELECTRO-KINETIC SOLUTIONS Inc., Toronto (CA)

(72) Inventors: Ed Hanna, Pickering (CA); John Vandersleen, Calgary (CA); Clare Armstrong, Hamilton (CA); Steven Spencer, Hamilton (CA); Barna Szabados, Ancaster (CA)

(73) Assignee: ELECTRO-KINETIC SOLUTIONS Inc., Toronto, ON (CA)

(21) Appl. No.: 18/835,260

(22) PCT Filed: Feb. 1, 2023
(86) PCT No.: PCT/CA2023/050139

§ 371 Date: Aug. 1, 2024

(30) Foreign Application Priority Data
Feb. 1, 2022 (CA) 3147378

(51) Int. Cl. C02F 11/15; C02F 103/10

(52) U.S. Cl. CPC C02F 11/15; C02F 2103/10; C02F 2201/46165

(57) ABSTRACT

A method for electrokinetic dewatering of slurries, consisting of parallel electrode pairs suspended in a slurry deposit. Deployment consists of pulling the ends of electrode sections across a deposit. If solar power is used, floating solar panels are connected to electrodes at fixed spacings and deployed concurrently with the electrode assembly. The electrodes are suspended below or above the mudline by floats. By inflating or deflating the floats, the electrode positions are remotely controlled. External sleeves on the electrodes are used to trap and vent gas generated at the electrodes that otherwise might prematurely terminate the dewatering process. An insulated supplementary conductor is intermittently connected to the anode to decrease power attenuation and mitigate the risk of anode failure. Grid power is regulated by a central control system at the edge of a deposit. Solar power is regulated by dispersed control systems on the floating solar panels.

### FIELD OF THE INVENTION

This invention relates to the field of dewatering technologies for use in stabilising, consolidating and reducing the volume of slurries from industrial processes like mine tailings, dredging spoils and wastewater sludges. The present invention relates specifically to the use of electrokinetics for dewatering slurries, soft soils and other saturated media.

### BACKGROUND OF THE INVENTION

Most mining produces tailings (i.e. the fine-grained waste remaining after an economic product has been extracted). These tailings, containing water, coarse and fine solid particles are often produced in large quantities and are commonly stored in tailings storage facilities. The tailings tend to segregate, with the coarser particles settling out relatively rapidly, leaving a slurry of fine-grained particles in suspension (slimes). These slurries can take decades or longer to settle. A geotechnically stable state adequate to support reclamation activities may not be achieved for decades or more if dewatering only occurs passively due to self-weight consolidation. This protracted dewatering timescale results in large quantities of unstable contaminated material being exposed to the environment, posing significant economic and environmental risks. Mineral production has increased greatly over the last 50 years and as a result, the total volume of tailings on the landscape has continued to expand unabated.

Environmental risks associated with these deposits include: 1) risk to fish and wildlife encountering polluted water, 2) accidental breach of containment dams and the release of large volumes of fluid slurry into the surrounding environment, 3) contamination of groundwater from polluted seepage emanating from the containment ponds, and 4) long-term release of air pollutants to the atmosphere including greenhouse gases.

Direct economic risks include: 1) the immediate and future costs associated with dewatering and reclaiming tailings, 2) the potential costs associated with accidental releases, 3) increased operating costs associated with maintenance and supervision of large tailings deposits, 4) increased costs due to extended space requirements to store large tailings deposits and 5) “freezing” of future exploitable deposits by the presence of large overlying tailings deposits.

Reducing the liability associated with tailings is essential for the economic future of the mining industry and its ability to attract investment in mining operations. For this reason, the International Council on Mining and Metals (ICMM) has introduced the Global Industry Standard on Tailings Management (GISTM). The Global Standard for Tailings Management sets out 15 principles to guide tailings management. These principles advocate new tailings treatment technologies in the design and operation of tailings storage facilities to accelerate the stabilisation and dewatering of tailings.

By dewatering unconsolidated tailings, the risk of catastrophic failure and the associated release of those tailings is eliminated. In addition, once the tailings are dewatered and consolidated, the area can be reclaimed and returned to its natural state. However, no commercial, low-cost technology is currently available that can rapidly dewater tailings so that reclamation can proceed in the near term.

Current tailings management practices vary from one mine to another. A common practice is to add coagulants (e.g. gypsum) and/or flocculants (e.g. polyacrylamides) prior to their discharge to tailings storage facilities. These additives reduce the water content somewhat but subsequent dewatering is extremely protracted, particularly when the fines content is high. With this approach, further dewatering occurs due to self-weight consolidation but the low hydraulic conductivity and great depth of many tailings deposits means that self-weight dewatering takes years to occur. Further, the highest density is achieved at depth while the surface remains fluid and unstable, preventing reclamation.

The problems associated with dewatering and reclaiming tailings have been widely documented and are a primary focus of environmental opponents to the industry. To date, little progressive reclamation of tailings has been achieved due to the absence of a technology capable of consolidating the tailings to a state that reclamation can occur in the near term.

The mining industry has invested a great deal of money searching for an effective means to dewater tailings. Despite frequent claims that an effective and reliable solution has been found, these solutions have repeatedly proven to be unreliable, and the problem continues to grow. For this reason, large investments researching new tailings management technologies are continuing to be made.

The use of electrokinetics to accelerate the dewatering of tailings, has been proposed in the past. Various lab tests with different electrokinetic configurations have been conducted but with limited success. A major challenge is scaling up these configurations to a commercial scale. Serious challenges emerge when scaling up in terms of energy consumption among other factors. Major improvements in both the economics and the functionality are required.

### SUMMARY OF THE INVENTION

What is desired is dewatering apparatuses, systems and/or methods that are improvements in one or more ways over the existing apparatuses, systems and/or methods.

According to an aspect of the invention, there is provided a method of deploying a set of electrodes in a deposit for the purpose of dewatering the deposit, wherein the deposit is contained in a tailings storage facility, the method comprising the steps of: providing at least a first mounting apparatus (which could be, for example, a rack or a spool) having a first electrode assembly mounted thereon, the first electrode assembly comprising a first set of cathodes and a corresponding first set of anodes connected thereto, the first electrode assembly further comprising a first plurality of positioning floats operatively connected to electrodes of the first electrode assembly; connecting the leading ends of the electrodes to at least one pulling apparatus positioned across the deposit basin from the first mounting apparatus; deploying the electrodes by using the pulling apparatus to pull the first electrode assembly into the deposit.

In an embodiment, the deposit includes a water cap on top of the deposit, and the electrodes are deployed by pulling the electrodes through the water cap. In an embodiment, the first plurality of positioning floats is tethered to the first set of cathodes, and each cathode of the first set of cathodes is tethered to a corresponding anode in the first set of anodes. In an embodiment, the pulling apparatus includes at least one winch. In an embodiment, the method further comprises the steps of: providing a second electrode assembly mounted on a mounting apparatus (which could be, for example, another spool or another layer of the first rack, or a second rack), the second electrode assembly comprising a second set of cathodes and a corresponding second set of anodes connected thereto, the second electrode assembly further comprising a second plurality of positioning floats operatively connected to electrodes of the second electrode assembly; connecting the leading end of the second set of electrodes to the trailing end of first set of electrodes; using the pulling apparatus to pull the first electrode assembly further into the deposit and thus also pull the second electrode assembly into the deposit. In an embodiment, the plurality of positioning floats are vertically tethered to the set of cathodes, and the set of cathodes is vertically tethered to the set of anodes.

In an aspect of the invention, there is provided an apparatus for dewatering a deposit, comprising: a plurality of cathodes and a plurality of anodes, each of the plurality of cathodes being tethered to a corresponding one of the plurality of anodes; a plurality of positioning floats vertically tethered to at least one of the plurality of cathodes and the plurality of anodes, the plurality of positioning floats being selectively inflatable and deflatable, when the plurality of cathodes and the plurality of anodes are deployed in the deposit, to adjust the vertical positions of the plurality of cathodes and the plurality of anodes within the deposit.

In an embodiment, each of the plurality of cathodes is vertically tethered to a corresponding one of the plurality of anodes, and the plurality of positioning floats is vertically tethered to the plurality of cathodes, such that in the deposit the plurality of cathodes is suspended from the plurality of positioning floats and the plurality of anodes is suspended from the plurality of cathodes. In an embodiment, the position of the apparatus may be adjusted, wherein the deposit comprises slurry and a water cap overlaying the slurry, wherein a border between the water cap and slurry defines a mudline, the adjustment comprising the step of, when the plurality of cathodes is positioned above the mudline, deflating the plurality of floats until the plurality of floats are positioned at the mudline, with the plurality of cathodes positioned at a first cathode position below the mudline and the plurality of anodes positioned in the slurry below the first cathode position. The adjustment may further comprise the step of partially inflating the plurality of floats to cause the plurality of cathodes to move upward from the first cathode position to a second cathode position that is below the mudline. The adjustment may further comprise the step of partially inflating the plurality of floats to cause the plurality of cathodes to move upward from the first cathode position to a cathode position that is above the mudline. The adjustment may further comprise the step of partially or fully inflating the plurality of floats to cause the plurality of cathodes to move upward from the second cathode position to a cathode position that is above the mudline.

In an embodiment, the plurality of cathodes comprises multiple sets of cathodes, and the apparatus further comprises a plurality of horizontal tethers, each of said horizontal tethers connecting one of said sets of cathodes to another of said sets of cathodes, wherein a horizontal position of the plurality of cathodes and the plurality of anodes may be adjusted by applying horizontal tension to the plurality of horizontal tethers when the plurality of cathodes and the plurality of anodes are deployed in the deposit. Each of the plurality of horizontal tethers may be coupled to at least one tensioning apparatus for applying tension to the plurality of horizontal tethers.

In an aspect of the invention, there is provided an electrode assembly for use in a deposit dewatering apparatus deployed in a deposit, the electrode assembly comprising: an electrode comprising at least one primary conductor; a supplementary conductor having mutually spaced intermittent electrical connections to the at least one primary conductor along a length thereof; insulation to electrically insulate the supplementary conductor from slurry and water in the deposit, and to insulate the supplementary conductor from the primary conductor between the intermittent electrical connections; and at least one power source connector for connecting the at least one primary conductor to electrical power. In an embodiment, the at least one power source connector connects the supplementary conductor to electrical power. The electrode may be an anode. In an embodiment, the at least one primary conductor comprises a plurality of primary conductors, and the supplementary conductor has intermittent electrical connections to each of the plurality of primary conductors. The intermittent electrical connections may be at least one metre apart from one another. The intermittent electrical connections may be no more than five metres apart from one another. The electrode assembly may comprise at least one spacer for holding the plurality of primary conductors in spaced relation to one another. The electrode assembly may comprise at least one spacer for holding the supplementary conductor in spaced relation to the at least one primary conductor. The electrode assembly may comprise at least two spacers for creating the mutually spaced intermittent electrical connections. The primary conductors may comprise a mixed metal oxide conductor or a sacrificial conductor. The plurality of primary conductors may comprise mixed metal oxide conductors. Each of the plurality of mixed metal oxide conductors may comprise a titanium core coated with at least one metal oxide selected from the group consisting of Rb₂O, RuO₂, IrO₂, PtO₂. The sacrificial conductor may comprise iron, aluminum, metal alloys such as stainless steel or other low-resistance electrically conductive material.

In an aspect of the invention, there is provided an electrode assembly to be deployed in a deposit of slurry to be dewatered, the electrode assembly comprising: an electrode for directing electric current into a portion of the deposit; a gas collar surrounding the electrode, and being spaced therefrom, for admitting water from the slurry into a space between the gas collar and the electrode, and for trapping gas generated by the electrochemical reactions at the electrode, the gas collar further comprising at least one gas vent for venting the gas out of the collar and out of the portion of the deposit. The electrode may be a cathode or may be an anode. The gas collar may comprise an outer water-permeable geofabric membrane and an underlying support structure comprising non-conducting mesh tubing positioned between the geofabric membrane and the electrode. The electrode assembly may further comprise at least one gas collar spacer for spacing the gas collar from the electrode to provide space for the liquid at the electrode.

In an aspect of the invention, there is provided an apparatus for dewatering a deposit, the apparatus comprising an electrode assembly, including anodes and cathodes, for dewatering a deposit by passing electrical current to the deposit, and a least one solar panel for powering the electrode assembly and for floating on the deposit, the at least one solar panel being electrically connected to the anodes and cathodes. The at least one solar panel may comprise a control system for distributing and regulating electrical power to the electrode assembly.

In an aspect of the invention, there is an apparatus and method for supplying power from solar panels floating above the electrodes in a deposit. These solar panels may provide DC power directly to the electrodes without any intermediate modulation, current conversion or battery storage to equalise the amount of current delivered over time. Each panel may be connected to one or more electrode assemblies and each assembly may have multiple panels connected along its length. The number, spacing and wiring of the solar panels may vary based on the physical and chemical characteristics of the tailings, the incident solar radiation, the dewatering objectives for the deposit and the availability and use of supplementary external power.

Where a solar panel is connected to multiple electrode assemblies, a control system may be used to distribute power among the assemblies according to a prescribed power schedule. The solar panels may be wired so that a group of solar panels may supply power to different combinations of electrode assemblies such that the total amount of power applied to individual or a group of electrode assemblies may be varied over a wide range.

In another embodiment of a method of deploying a set of electrodes in a deposit that includes a water cap on top of the deposit, during the process of pulling the electrode assembly into the deposit, floating solar panels are connected to the electrode assembly. With this embodiment, the solar panels may be positioned on the berm, at a designated spacing, beside an electrode assembly and before the assembly is fully pulled into the deposit. Each solar panel may be connected to a multitude of electrode assemblies by cables stretching from one electrode assembly to another. Also, with some embodiments, the solar panels may be electrically connected to each other. These connections may be made before the solar panels are pulled into the deposit.

### BRIEF DESCRIPTION OF THE DRAWINGS

By way of example only, reference is made to preferred embodiments of the invention as shown in the following drawings, in which:

FIG. 1 is a plan view schematic diagram of a dewatering apparatus during deployment according to an embodiment of the present invention;

FIG. 2 is a side view schematic of a dewatering apparatus during deployment according to an embodiment of the present invention;

FIG. 3 is a side view schematic showing the positioning of an electrode array in a deposit according to an aspect of the present invention;

FIG. 4 is a side view schematic showing an alternative positioning of an electrode array in a deposit according to an aspect of the present invention;

FIG. 5 is a plan view schematic showing a dewatering apparatus that has been deployed in a deposit, including a tether matrix for positioning of the electrodes;

FIG. 6 is a plan view schematic showing a dewatering apparatus deployed in a portion of a deposit;

FIG. 7 is a diagram showing a cross-section of a sacrificial anode encased in a gas collection sleeve according to an aspect of the present invention;

FIG. 8 is a diagram showing a cross-section of a mixed-metal-oxide (MMO) anode encased in a gas collection sleeve according to an aspect of the present invention;

FIG. 9 is a diagram showing a cross-section of a cathode with a gas collection sleeve according to an aspect of the present invention;

FIG. 10 is a side view schematic of an MMO anode with a gas collection sleeve, according to an aspect of the invention;

FIG. 11 is a schematic showing the electrokinetic and physical forces that drive the dewatering process;

FIG. 12 is a diagram showing an example of non-conductive spacer used with MMO anodes and gas collection sleeves, according to an aspect of the present invention.

FIG. 13 is a schematic showing the positions of solar panels in a deposit after an electrode assembly is deployed in its final position;

FIG. 14 is a schematic showing a vertical cross-section of the electric connections between the solar panels and the electrode assembly;

FIG. 15 is a side view schematic diagram of a dewatering apparatus during deployment according to an alternative embodiment of the present invention; and

FIG. 16 is a plan view schematic diagram of a dewatering apparatus during deployment according to the alternative embodiment of the present invention.

### DETAILED DESCRIPTION OF THE PREFERRED EMBODIMENTS

The present invention is described in more detail with reference to exemplary embodiments thereof as shown in the appended drawings. While the present invention is described below, including preferred embodiments, it should be understood that the present invention is not limited thereto. Those of ordinary skill in the art having access to the teachings herein will recognize additional implementations, modifications and embodiments which are within the scope of the present invention as disclosed and claimed herein.

At the outset, it is noted that the exemplary embodiments of the invention are described below in the context of dewatering mine tailings deposits. However, the present invention is not limited to the dewatering of mine tailings generally, but comprehends electrokinetic dewatering of many types of slurries and soils (all referred to herein generally as “deposits”), no matter how or where they are lying, collected and contained or deposited. Without limitation, other deposits that are comprehended by the present invention may include fly ash, dredging spoils, municipal and industrial wastewater sludges, soft clayey soils and marine sediments. These materials are materials that either do not dewater naturally or dewater slowly without intervention. This invention is also suitable for dewatering and stabilising unstable slopes and dams including tailings dams confining tailings deposits.

The preferred embodiment of this invention includes an array of horizontal electrodes supported by remotely controlled, adjustable floats and with the applied power regulated automatically by a central control system. The electrode array is designed to use electrokinetics to dewater tailings or other materials in a tailings storage facility or in other containment structures or uncontained material at the bottom of a waterbody such as the tailings or sediments on the bottom of end-pit lakes or present in low-lying areas or saturated or submerged soils that are potentially unstable. In this document, any containment of any deposit, whether naturally occurring (e.g. a depression in the ground containing a pond) or man-made, may be referred to as a basin.

An electrode array may comprise parallel sets of cathodes and anodes. The electrodes may be precisely positioned relative to one another in terms of their horizontal and vertical spacing and within a deposit to maximize dewatering efficiency. The electrode spacing partly determines the shape and strength of the electric field which in turn regulates the electrokinetic processes. The electrodes are typically horizontal with the cathode above the anode but the electrodes may also be vertically oriented. Also, the anodes may be above the cathodes for some applications.

The number of electrode pairs and their lengths may vary with the dimensions and shape of the deposit to be dewatered. The horizontal spacing may be varied depending on the desired dewatering rate and the desired final state in terms of water content. The vertical spacing may be varied depending on the bottom contours of the deposit, the desired dewatering rate and the desired final state in terms of water content.

In deposits with a water cap (that is, with a layer of water over the slurry) or in which the slurry has inadequate strength to support the electrodes, the electrode array may be supported by adjustable floats. These floats may be inflated or deflated remotely from time to time. By inflating or deflating the floats, the vertical positions of the cathodes and anodes may be remotely adjusted.

One method for deploying the electrodes in a deposit with a water cap may be to mount the electrodes on mounting apparatuses such as transportable spools along a berm containing a deposit and pulling the electrodes into position using tethers and winches mounted on the opposing berm. A variation of this deployment method is to mount the prefabricated electrodes on mounting apparatuses such as transportable racks 80 that are off-loaded along the deposit and from which the electrodes are drawn sequentially into the tailings deposit. The floats, cathodes and anodes may all be prefabricated and sections of the electrode pairs may be connected using prefabricated connectors 79, one end to the other, during the deployment process. It will be appreciated by the person skilled in the art that the invention comprehends other types of mounting apparatus for deployment of the electrodes besides those described herein (i.e. spools and racks, including layered racks, with each layer having at least one electrode assembly mounted thereon for deployment)

During deployment, the mounting apparatus for each set of floats and electrode elements may be positioned along the berm so that a precise horizontal separation between the parallel sets of electrodes may be achieved. As each set of electrode elements and floats is pulled into position, horizontal tethers 32 between adjacent cathodes may be attached at regular intervals. When the end of an electrode section is reached, the trailing ends of the electrode elements may be connected to the leading ends of a new section of electrode elements. Once all connectors 79 are applied, the deployment process may recommence with the sections being pulled together into the deposit. In this manner, an electrode assembly longer than what could fit on a single spool/rack length, can be deployed.

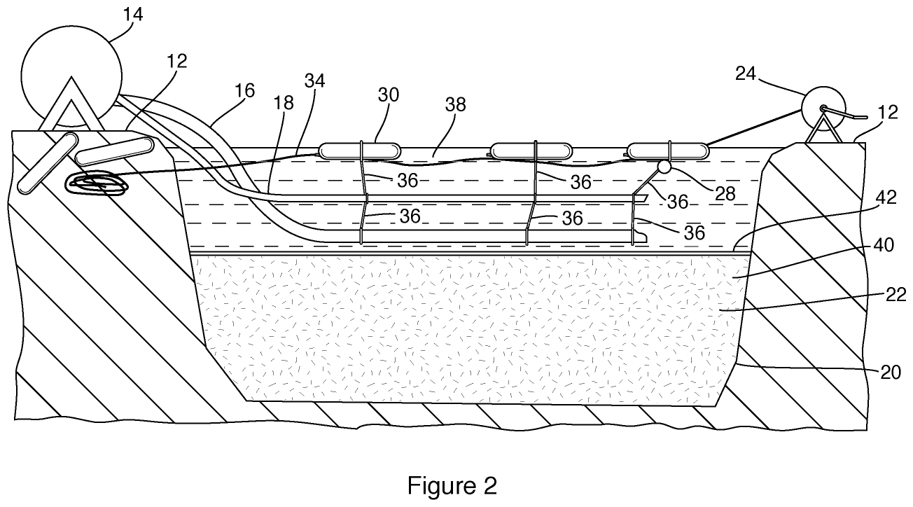

While the electrodes are being deployed, the floats may be fully inflated such that the electrodes are suspended just below the water cap surface (FIG. 2). As a result, the electrodes can be easily drawn across even large deposits with little resistance from the underlying tailings.

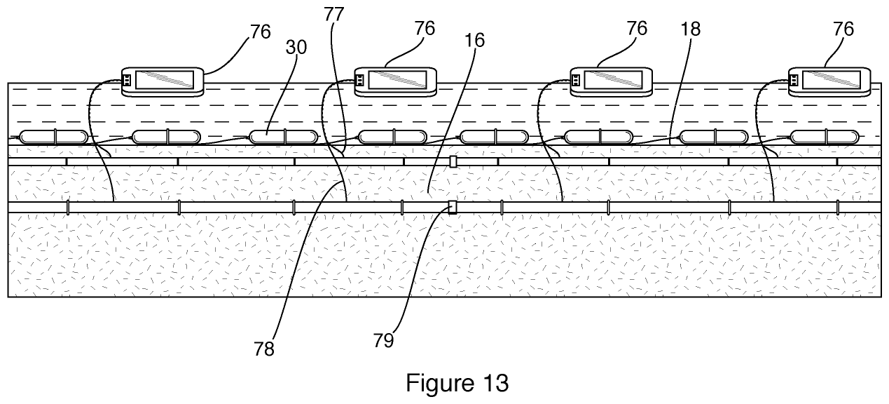

If the installation will be powered by solar power, solar panels 76 may be positioned and deployed at the same time that the electrode elements are being deployed. In this case, all electrical connections 77 to the cathodes and 78 to the anodes are made between the solar panels and the electrodes, before the electrode assembly is pulled further into the deposit. As the electrode assembly is pulled into position, the solar panels 76 are also pulled into position across the surface of the water cap. FIG. 13 shows an example the positioning of solar panels 76 within a deployed electrode assembly. The number and area of solar panels and their positioning may depend on the available solar radiation and the dewatering objectives for the deposit.

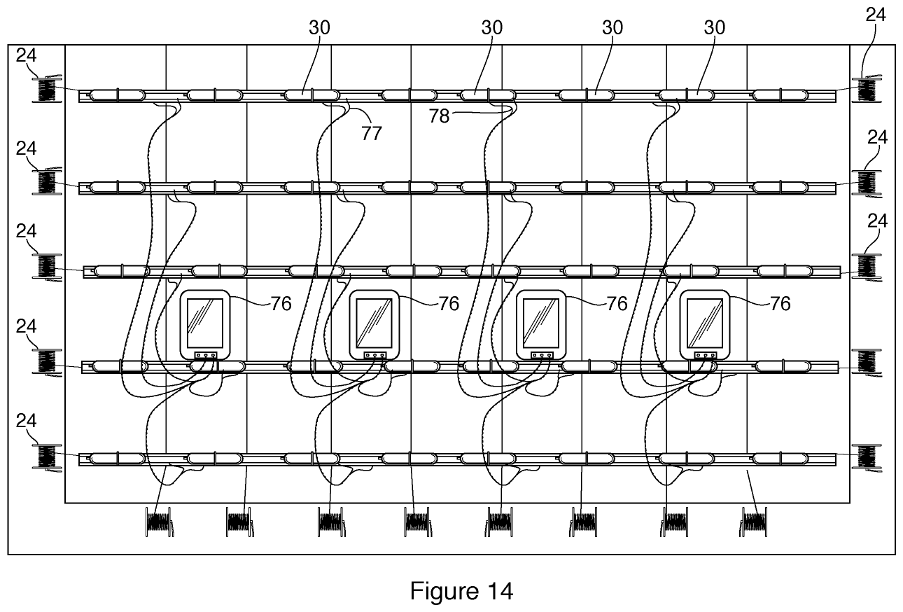

FIG. 14 shows the connections 77 and 78 that need to be made between the solar panels and the electrodes prior to the panels being deployed with the electrode assembly. Each connection may be sealed with water-tight material to avoid corrosion during the dewatering process or may consist of corrosion-resistant material.

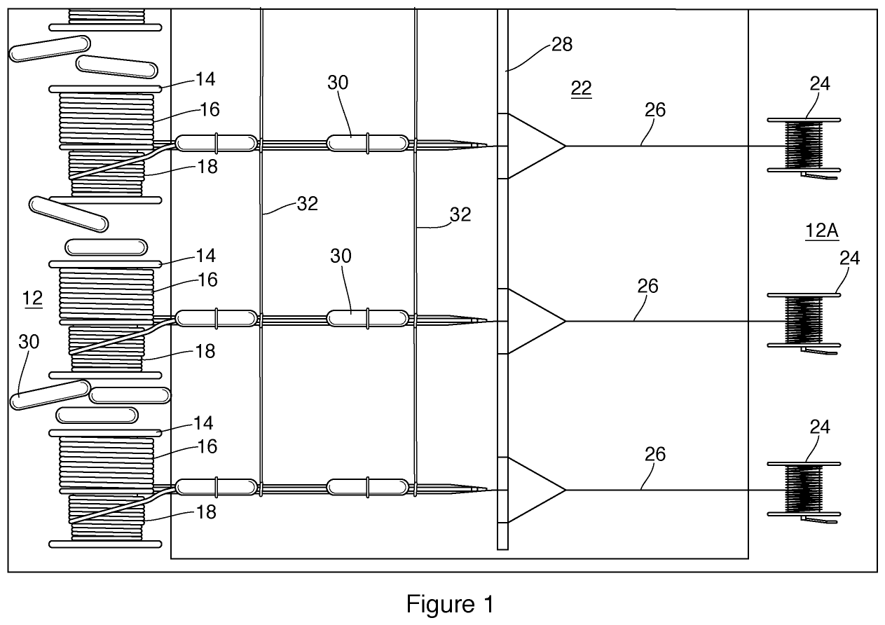

FIG. 1 shows an embodiment of this deployment method using spooled electrodes. Spools 14, each carrying spooled anode 16 and spooled cathode 18, are positioned on berm 12, for deployment of the electrodes into deposit 22, which may comprise mine tailings. Deposit 22 may be contained within tailings storage facility 20, in the form of a below-grade depression in the ground or as an above-grade deposit contained by surrounding berms and terrain features. It will be appreciated, however, that the invention may be installed and used with other types of deposit containments or basins and is not limited to tailings storage facilities.

Prior to deployment, winches 24 are set up on berm 12 opposite to the electrodes on the other berm. Winches 24 are connected via cables 26 to draw bar 28. Draw bar 28 is connected to the ends of cathode 18. As winches 24 are activated, wires 26 are wound onto the winches, the draw bar 28 is pulled toward the winches, and anode 16 and cathode 18 are pulled across the deposit until they are in position for dewatering.

Floats 30 may be attached to cathode 18 as cathode 18 and anode 16 are being deployed, for example, by stopping the winching intermittently, attaching another float and then resuming the winching. Alternatively, the floats may be attached to cathode 18 and anode 16 during the fabrication and deployed as one unit.

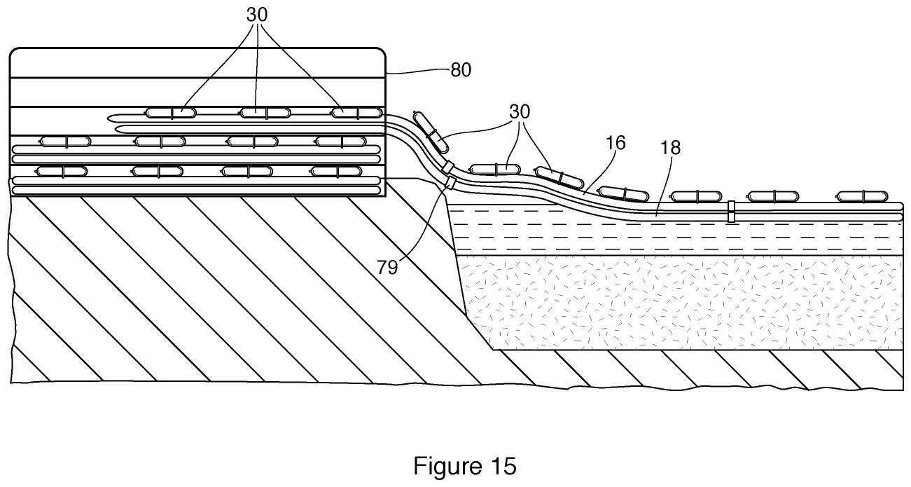

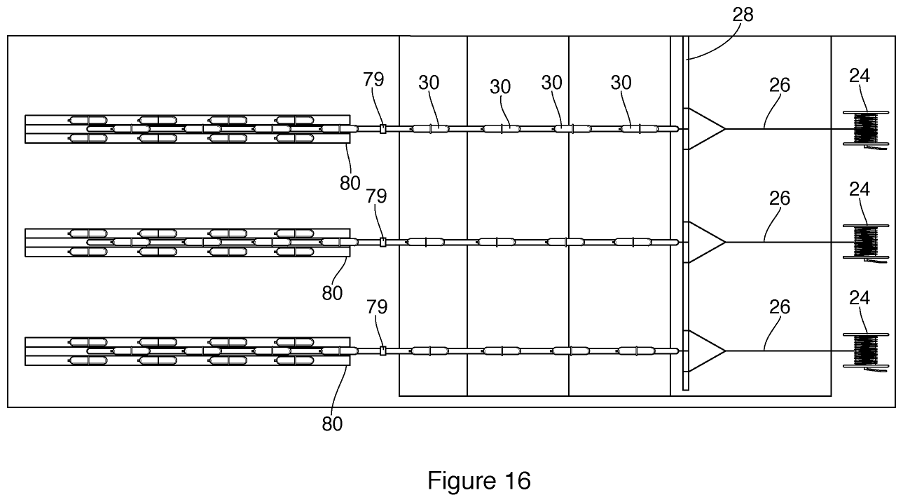

It will be appreciated by those skilled in the art that the method of deploying electrodes from a spool as described above applies mutatis mutandis to deployment from a rack, such as a layered rack 80 as shown in FIG. 15. In that rack, each layer of the rack can include one or more additional electrode section to be attached end-to-end to previously deployed electrode sections, as described below.

Preferably, the dewatering apparatus includes horizontal tethers 32 which tether each set of electrodes to the adjacent set. As can be seen in FIG. 1, the electrodes are preferably deployed in an array of sets of electrodes, parallel to each other and to the surface of the deposit. During deployment, horizontal tethers 32 are attached to the adjacent electrode pair.

The apparatus, including multiple sets of electrodes, occupies the deposit, or some portion thereof, to dewater the deposit, or some portion thereof.

As described above, if the electrodes are too long to fit on a single spool or rack, they can be deployed using multiple successive sections, with each successive electrode section being connected end-to-end to form one long electrode set.

As shown in FIG. 2, anode 16 and corresponding cathode 18 are tethered by vertical tethers 36. The precise horizontal and vertical positions of the electrodes relative to one another and relative to their position in the deposit may be achieved and maintained using the lattice of horizontal tethers 32 and vertical tethers 36. When the electrodes are fully deployed, their positions may be fine-tuned using the lattice of horizontal tethers 32. Preferably, tethers 32 and 36 are non-conductive flexible straps, composed, for example, of nylon.

As shown in FIG. 2, a deposit 22 will typically include water cap 38 positioned above slurry portion 40. The border between water cap 38 and slurry 40 is referred to as mudline 42. FIG. 2 further shows air hose 34 that connects floats 30 positioned above each set of electrodes. Air hose 34 is preferably connected to a device allowing for selective inflating and deflating of floats 30. Most preferably, such a device is a compressor (not shown) whose pressure is controlled to adjust the level of inflation of the floats.

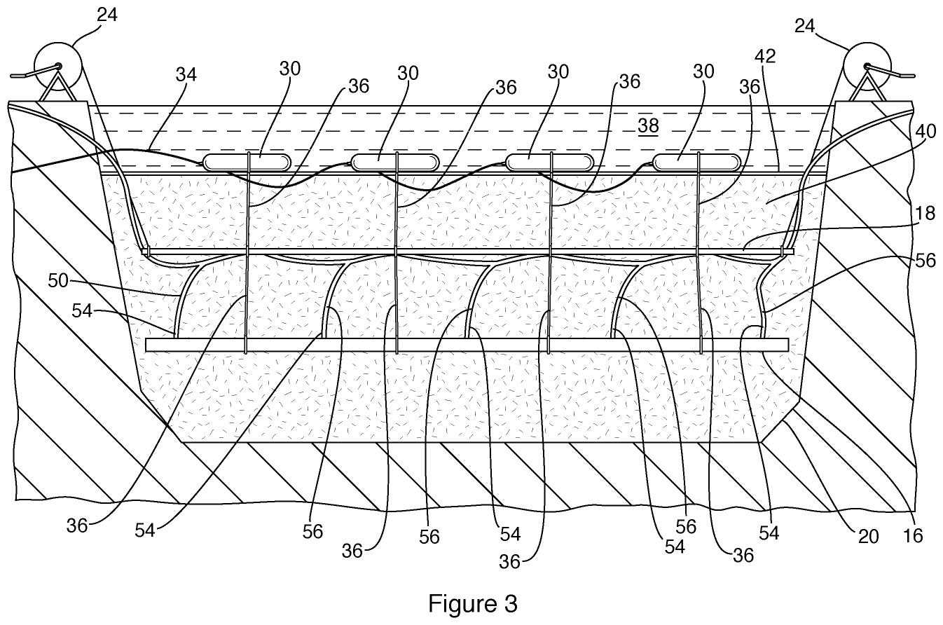

The mudline is a distinct transition from water cap 38 to underlying slurry 40. The density of underlying slurry 40 is typically greater than that of water cap 38. Once the electrodes are in position, by slowly deflating floats 30, floats 30 sink through water cap 38 and come to rest on mudline 42 with the electrodes suspended below. This positioning can be seen in FIG. 3, with floats 30 at mudline 42, and both cathode 18 and anode 16 in slurry 40.

By applying moderate tension to horizontal tethers 32, the electrodes can be kept horizontally parallel to one another throughout the dewatering process. The initial vertical spacing may be achieved by the weight of anode 16 pulling down on cathode 18 which in turn pulls down on supporting floats 30 resulting in vertical tethers 36 being pulled taut and the components aligned vertically. The vertical separation of each float-cathode-anode set may be equal to the length of vertical tethers 36 between the float-cathode-anode set. As shown in FIGS. 3 to 6, after deployment, the deployment equipment is preferably replaced by winches 24. Winches 24 are preferably positioned on all sides of basin 20. The winches are used to apply moderate tension, maintaining the desired horizontal spacing and the position of the electrode assembly in basin 20.

Using this deployment method, the electrode array may be ideally positioned within a deposit. By precisely positioning the electrodes near the mudline and parallel to one another, major improvements in the dewatering rate and energy efficiency may be achieved. When the electrodes are in position, power may be applied and the dewatering process begins.

The vertical position of an electrode array installation may be designed to passively respond to changes that occur during the electrokinetic dewatering process. During the electrokinetic dewatering process, the water content of slurry 40 decreases between the electrodes. The pore water is released to water cap 38. As a result, the volume of slurry 40 decreases over time causing mudline 42 to sink if new fresh tailings are not added. As the mudline sinks, so too do electrodes 16 and 18. As a result, the desired position of the electrodes relative to the mudline is maintained.

When fresh tailings are being continually added, the mudline may rise despite dewatering by the electrodes. In this case, floats 30 rise with the mudline as do the electrodes but the position of the electrodes relative to the mudline stays the same.

A density gradient between anode 16 and cathode 18 forms during the dewatering process. The highest density material is proximal to anode 16. During the dewatering process, the higher density tailings sink and lower density tailings flow in from the top. This dynamic flow continues until the density of the mound of dewatered tailings below the anode builds up to the point that the underlying density is great enough to cause anode 16 to become buoyant and for its weight to be supported by the underlying solids in slurry 40. At this point, the vertical separation between anode 16 and cathode 18 may begin to decrease which may cause the strength of the electric field to increase. The anode 16 can be designed to have a particular buoyancy such that it will become buoyant and stop sinking when the dewatered tailings below the anode reach a predetermined density.

Over the course of the dewatering process, the applied power to the electrodes may be incrementally increased. As the density of deposit 22 increases, its electrical resistance increases. To maintain a constant current density, the applied voltage may be increased to offset this increased resistance.

If power is applied from an external source, the power to each electrode pair may be regulated by a central control system. If solar power is used, a dispersed network of control systems may switch power between electrode pairs to concentrate the available solar power and to increase the applied power sequentially among electrode pairs.

As the density of deposit 22 increases, the resistance of the particles in slurry 40 to compaction increases. The weight of the overlying solids is increasingly supported by the underlying particles. The result is that the pore water pressure decreases causing the upward hydraulic pressure to decrease which in turn causes the dewatering rate to decrease. Increasing the strength of the electric field increases the electroosmotic force which can counteract this reduced hydraulic pressure on the pore water and a constant dewatering rate may be retained. The strength of the electric field is increased by increasing the applied voltage to anode 16 and cathode 18.

Increasing the electric field strength tends to reduce the energy efficiency of the dewatering process. On the other hand, reducing the vertical separation between anode 16 and cathode 18 may increase energy efficiency. The result of the induced reduction in the vertical separation between anode 16 and cathode 18 later in the dewatering process may offset the impacts of increasing electrical resistance and the need for a higher applied voltage to compensate for the reduced hydraulic pressure on the pore water in slurry 40. The reduction in the vertical separation between cathode 18 and anode 16 may occur when dewatering energy efficiency is declining, resulting in significant improvements in dewatering energy efficiency compared to maintaining a fixed vertical separation.

Another advantage of the separation distance decreasing later in the dewatering process may be an improvement in the density profile within slurry 40. During the dewatering process, the densest material tends to be located around and below anode 16. Conversely, the least dense material is around and above cathode 18. As the vertical separation between anode 16 and cathode 18 decreases, the density of slurry 40 between anode 16 and cathode 18 may increase. As a result, at the end of the dewatering process only a thin layer of lower density solids may remain around cathode 18.

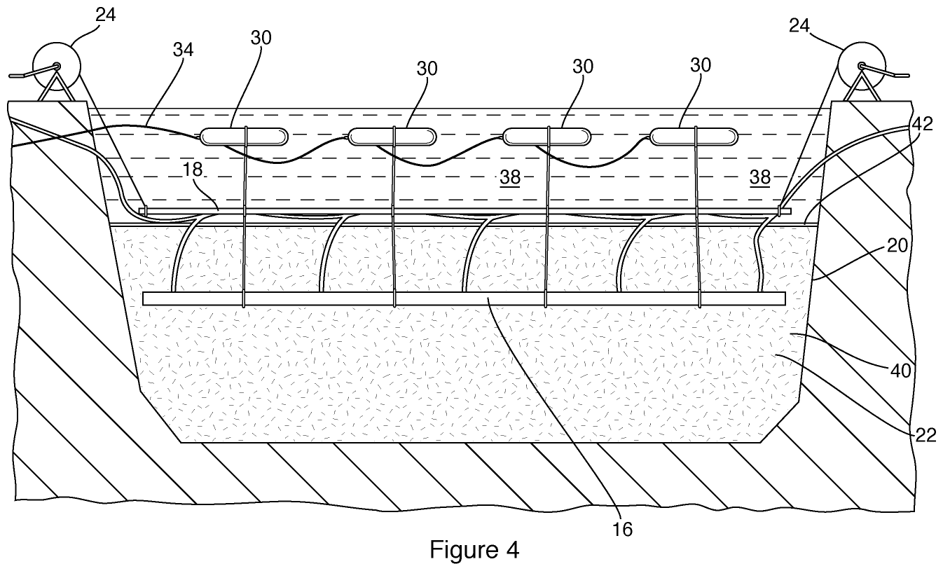

As shown in FIG. 4, an alternative method for operating the system toward the end of the dewatering process is to inflate floats 30 slightly so that cathode 18 may be drawn upward toward the mudline 42 or even above mudline 42. In this position, the lower density solids around cathode 18 may undergo further dewatering and become consolidated. This method overcomes the problem of a residual layer of low-density solids at the surface around cathode 18 at the end of the dewatering process. When dewatering is complete, anode 16 is just below mudline 42 and the entire zone that was originally between anode 16 and cathode 18 is uniformly densified. This method may be used to form a solid cap on the top of what would have otherwise been a top layer of slurry 40 at the end of the dewatering process.

Another method is to maintain cathode 18 in water cap 38 above mudline 42 from the start of the dewatering process. This configuration has the benefit of clarifying the water cap using electrophoresis while dewatering of the solids in the top layer of slurry 40. This configuration may be valuable where reuse of the water in water cap 38 is desired and having low suspended solids concentrations in the recycled water is desirable. If low suspended solids in water cap 38 is desirable, external sleeve 43 (described further below) may be used with the cathodes as well as the anodes.

Another alternative application is to use the electrodes to clarify water cap 38 before floats 30 are partially deflated and the electrodes are submerged in slurry 40. This method may be attractive where the water cap water has sufficiently high suspended solids that clarification is required before the water can be reused. With this application, the invention may be operated to eliminate suspended solids and to prevent the recurrence of high suspended solids concentrations during the dewatering process. In this way, continual withdrawal of clarified reuse water from water cap 38 may occur over the course of the dewatering process. External sleeve 43 may be used with the cathodes as well as the anodes with this application as well.

The invention may be used for static deposits such as inactive tailings storage facilities. The invention may also be used for active deposits that are receiving fresh tailings or other types of slurries on a continuous basis. With active deposits, mudline 42 rises over time. In the absence of the operation of the invention to dewater the deposit, the rate of rise of mudline 42 will be much faster, causing the storage capacity of basin 20 to be consumed more quickly. However, the invention may be used to release water on a continuous basis, reducing the rate at which mudline 42 rises, significantly increasing the effective capacity of expensive tailings storage facilities. As mudline 42 rises, the electrodes automatically rise as well. The result may be that electrodes remain positioned at the ideal location relative to the mudline where dewatering is most efficient.

The electrodes are preferably powered with DC current. DC current does not pose the same electric shock and electrocution hazards that are present when AC current is in contact with water. As a result, the system may be powered while other operations are occurring within an active deposit without undue electrocution hazards although powering off the invention when operations are occurring in the immediate area of the electrodes is recommended. The power may be turned on and off to the invention without disrupting the dewatering process.

The power supply and central control system of the dewatering apparatus may be modular and mobile. When dewatering of one deposit 42 is completed, these expensive components may be transported and reused for another dewatering project. Also, the cathodes 18 and floats 30 may be recovered and reused. Though there may be exceptions, the anodes typically are not reused after extended operation of the invention. At the end of the dewatering process, the cathode 18 and floats 30 may be refloated to the surface of the water cap and recovered for refurbishment and redeployment. If solar panels are used, these too can be reused in multiple tailings storage facilities or they can remain in place to supply sustainable energy for other purposes.

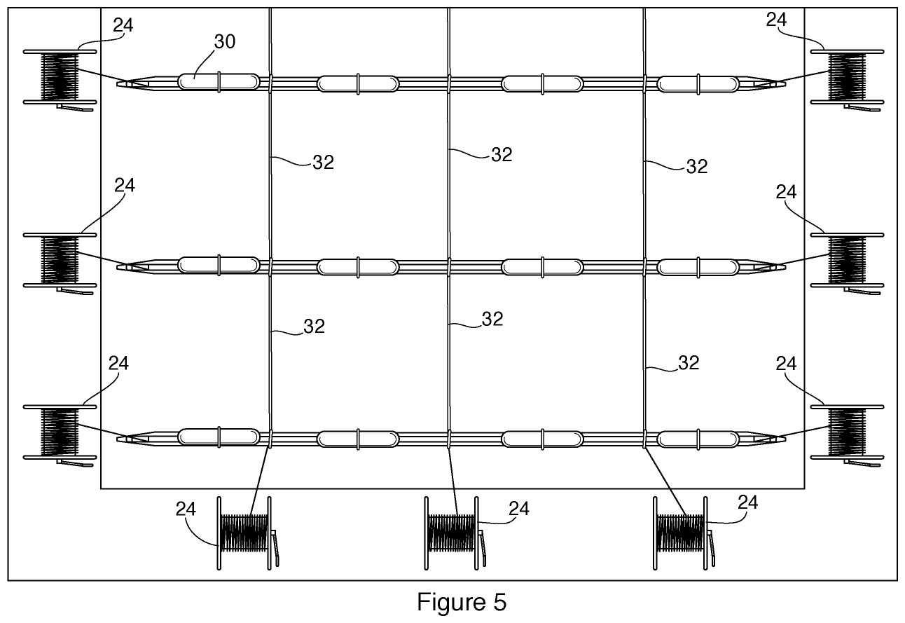

The electrodes may be designed to dewater an entire deposit at one time. In this case, the electrode array may be designed to cover all or most of the area of a deposit, as shown in FIG. 5. In this embodiment, mudline 42 throughout the deposit recedes more or less uniformly.

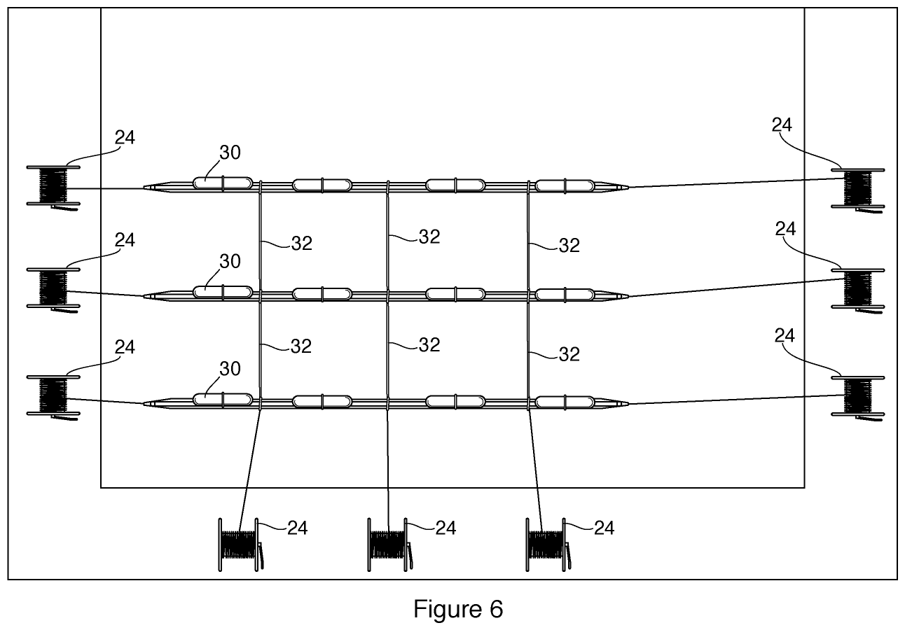

An alternative method is to cover only a portion of the deposit with electrodes initially, as shown in FIG. 6. With this method, only mudline 42 above the electrodes drops vertically. Depending on the density and viscosity of the solids in slurry 40, inward hydraulic flow of the surrounding the surface layer of slurry 40 may occur above the electrodes causing a slope to form in the local mudline toward the array. The angle of this slope may be related to the density of the top layer of slurry 40 and its rheological characteristics. The extent of this slope will partially depend on the density and viscosity of the solids in slurry 40. Due to this dynamic flow of the upper layer of slurry 40, the electrode array as shown, for example in FIG. 6, may dewater a larger area than its footprint.

With this alternative method, the electrode array may be strategically moved throughout a deposit using, for example, horizontal tethers 32 and winches 24 such that different sections of a deposit may be dewatered sequentially. This method may be used with inactive and active deposits. With active deposits, the location of the electrode array(s) may be selected based on the location(s) of the spigot(s) discharging to a deposit. The array(s) may be positioned away from the initial discharge point(s) so that the energy efficiency of the dewatering process is greatest and the most-difficult-to-dewater fine-grained solids are dewatered and energy is not used to dewater the coarser-grained particles near the spigots which tend to dewater rapidly without intervention.

Two basic types of anode 16 may be used, namely, sacrificial and dimensionally stable. Sacrificial electrodes may be preferred for inactive deposits where dewatering is occurring only once. Dimensionally stable anodes may be preferred in active deposits continuously receiving fresh slurry 40 and where dewatering may be occurring continuously for an extended period of time. Dimensionally stable anodes may also be attractive where deposits are being sequentially filled, dewatered and filled again.

During the electrokinetic process, electrolytic reactions occur at both anode 16 and cathode 18. These electrolytic reactions effect the transfer of the current into and out of the solids. Two basic types of electrolytic reactions may occur.

One reaction is the electrolysis of water. At anode 16, water molecules are broken into oxygen (O₂) and protons (H⁺). Also, in the case of sacrificial anodes, the anode metal may be corroded, releasing positive ions (cations) into the porewater. The release of protons and the hydrolysis of the metal cations released from anode corrosion cause the local pH to decrease.

At cathode 18, electrolysis of water is the primary electrolytic reaction, resulting in the formation hydroxide (OH⁻) and hydrogen gas (H₂). The release of hydroxide causes the local pH to increase. The combined result is that a strong pH gradient may form between anode 16 and cathode 18.

These electrolytic reactions and their reaction products typically affect the design and operation of the invention. In the case where the electrodes are sacrificial, the anodes in particular are typically designed based on the following considerations:
1. the amount of water that needs to be removed from slurry 40,
2. the amount of current required to achieve the desired dewatering,
3. the proportion of the current passing from the anodes to the deposit via anode corrosion,
4. the total mass of metal that will be corroded during the dewatering process, and
5. the distribution of the metal corrosion along the length of the anode.

The functional life of sacrificial anodes may be partly determined by their total mass. Thus, a given amount of dewatering would require a corresponding mass of metal in the sacrificial anode.

Even if adequate metal mass is specified, anode 16 may not last until the desired amount of dewatering has occurred, because the corrosion of the metal ions from the surface of anode 16 may not be even. Specifically, pitting may occur, resulting in uneven metal loss. This uneven pattern may result in anode 16 corroding through, resulting in the loss of electrical connectivity between the power source and the portion of anode 16 beyond the corrosion gap. If this occurs, the section of the electrode beyond the failure point becomes nonfunctional, resulting in uneven dewatering, and reducing the functional life of the remaining section of the electrode.

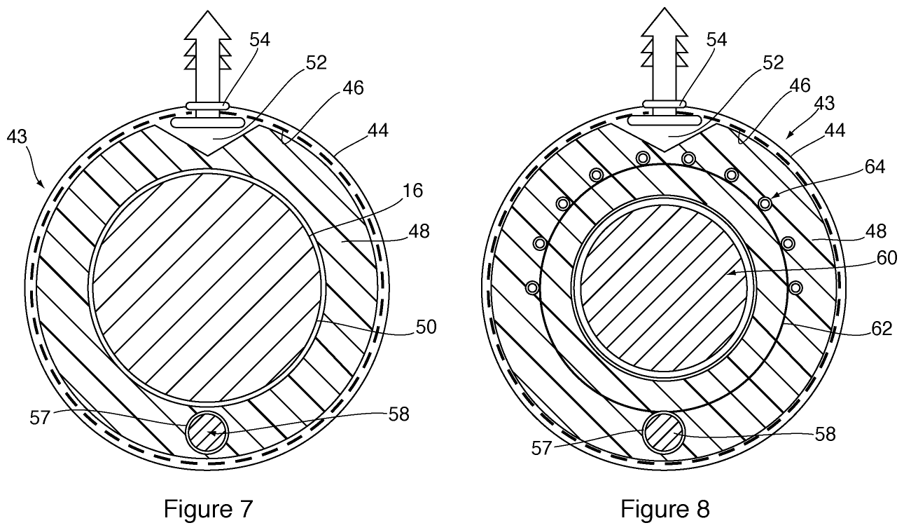

Supplementary conductors, referred to herein as “jumper cables” 58, may be used to mitigate this risk. If a section of anode 16 corrodes unevenly, and in the extreme, severs anode 16 completely, the current may be carried over this narrowed area or gap by jumper cables 58 so that the remaining sections of anode 16 remain functional. Jumper cables 58 are preferably connected intermittently along the length of anode 16, and may, for example, be connected to anode 16 at regular intervals generally every 1 to 3 m. Jumper cables 58 are preferably insulated except at points of connection to anode 16 and may be composed of copper. The insulation prevents corrosion of jumper cables 58 when they are submerged in slurry 40. The connections between jumper cables 58 and anode 16, which are themselves prone to corrosion, are preferably protected with a water-tight covering to avoid corrosion of exposed metal of jumper cables 58 or the connection devices between jumper cables 58 and anode 16. Corrosion protection may be achieved with a thick and complete coating of corrosion-resistant paint, shrink-wrap sleeves or other devices that prevent contact of the metal connection to the surrounding slurry 40. Insulated jumper cable connections to the anode 16 are shown at reference numeral 75. See generally FIGS. 7, 8, 10 and 12.

With sacrificial anodes, most of the mass of anode 16 may be corroded by the end of the dewatering process. These corroded metal ions may be bound in the solids of slurry 40, particularly as they migrate toward cathode 18 and the pH increases. Sacrificial anodes may also be used, in special cases, to induce localized electrocementation where increased geotechnical strength is desirable.

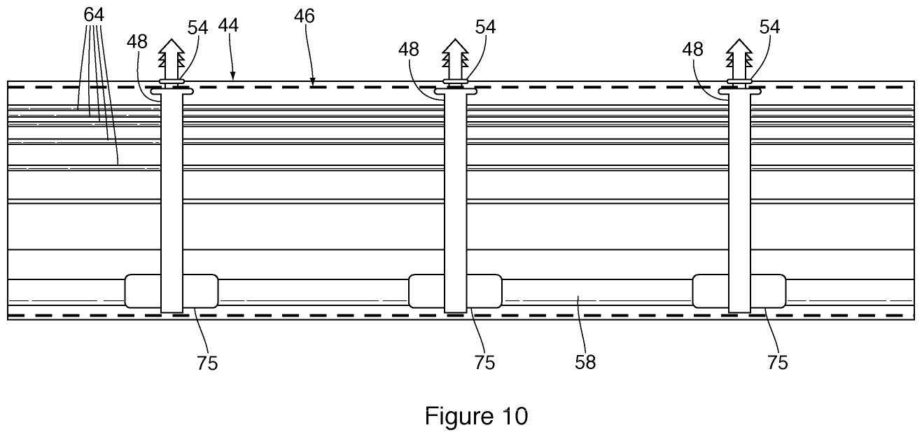

FIG. 7 shows a cross-sectional view of a sacrificial anode assembly according to an embodiment of the present invention. External sleeve 43 of the sacrificial anode comprises a geofabric membrane 44 supported internally by a plastic mesh 46. The sacrificial anode assembly further comprises multiple non-conductive spacers 48, intermittently positioned along sacrificial anode to maintain separation between the sleeve and the sacrificial anode. (FIG. 10 shows such intermittently placed non-conductive spacers 48, though FIG. 10 is otherwise directed to a different embodiment.) Non-conductive spacer 48 includes flow spaces 52 which permit gas generated by electrolysis to flow within the sleeve portion across non-conductive spacer 48. The assembly further comprises venting ports 54 to release gas generated by the electrodes to the atmosphere, preferably through vent hoses 56 (see FIG. 3). As described above, jumper cable 58 is intermittently electrically connected to anode 16. A similar external sleeve may be used in some applications to collect gas from cathode 18.

The pH of the porewater surrounding anode 16 decreases as protons are released. The rate of the pH decrease depends on the current, the proportion of the electrolysis that occurs through dissociation of water as opposed to the corrosion of anode 16 and the diffusion rate of the pore water. The more current that passes by corroding metal ions, the less is the drop in pH but the greater is the rate of loss of metal from anode 16. As the pH drops, the rate of electrokinetic dewatering slows and can eventually reverse direction if the pH becomes sufficiently acidic. Likewise, reversal can happen if the pH climbs too high. The pH around cathode 18 rises as dewatering progresses.

Tracking the pH in the vicinity of the electrodes may be useful. If need be, the polarity of the electrodes may be reversed, causing the local pH around anode 16 to increase and the pH around cathode 18 to decrease.

The release of gas can impact the dewatering process, particularly in the vicinity of anode 16. Over the duration of the dewatering process, mainly due to electrolysis, gas layers may form above anode 16. When a gas layer forms, electrical current may be blocked and the electric field may be disrupted or eliminated altogether. Venting this gas to the surface may be useful to avoid disruption of the dewatering process.

Accordingly, anode 16, and in some cases cathode 18, may be fitted with external sleeve 43, as shown in FIGS. 7, 8 and 9. Venting ports 54 are distributed along the tops of external sleeve 43. Tubes 56 (see FIG. 3) run vertically along the vertical tethers 36 to a horizontal central gas collection system that may vent the gas to the atmosphere. Alternatively, the gases from anode 16 and/or cathode 18 can be collected and combined to generate energy, further improving the energy efficiency of the system.

External sleeve 43 may be composed of fine-pore geotextile 44 supported by rigid plastic mesh 46. Pore water, but not the solids, from slurry 40, seeps into external sleeve 43 through the pores of geotextile 44 during deployment. However, as external sleeve 43 sinks into slurry 40, inward pressure builds tending to cause the external sleeve 43 to collapse. To offset the risk of collapse, non-conductive spacers 48, such as, for example, HDPE spacers, may be installed at regular intervals along the length of each electrode, as shown, for example, in FIG. 10. Non-conductive spacer 48 may include holes 57 through which jumper cables 58 pass helping to keep them in place. At the top of non-conductive spacer 48, gap 52 is present between the edge of non-conductive spacer 48 and geotextile 44. Gap 52 allows the gas that may accumulate on the underside of geotextile 44 to flow toward adjacent vent 54.

The design of dimensionally stable anodes differs from that of sacrificial electrodes, although their operation is similar. MMO (mixed metal oxide) anodes may be designed for extended continuous dewatering applications, for example, as in the case of an active slurry containment like a tailings storage facility where fresh slurry 40 is being constantly added. The much longer functional life of dimensionally stable anodes allows greater volumes of water to be released over a longer period of time using the same electrode array. Use of dimensionally stable anodes may reduce the costs of fabricating and installing new sacrificial anodes. Dimensionally stable anodes have a much longer functional life which also allows additional options for their operation.

Dimensionally stable anodes may be composed of corrosion resistant MMOs. Such electrodes might be composed, for example, of a titanium core with coatings of one or more of rubidium oxide (Rb₂O), iridium oxide (IrO₂), ruthenium oxide (RuO₂) or platinum oxide (PtO₂), though other conducting cores and metal oxides are comprehended by the invention. Since anode corrosion is much less with MMO anodes compared to sacrificial anodes, MMO anodes may have significantly lower mass than sacrificial electrodes. Accordingly, the design of MMO systems typically differs from designs based on sacrificial anodes.

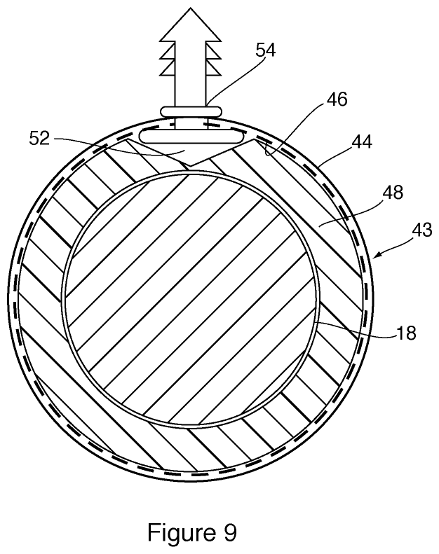

The preferred embodiment of dimensionally stable anodes is shown in FIGS. 8, 10 and 12, with the example electrode elements in those figures comprising an anode. This example anode comprises a plurality (ten in these figures) of MMO wires 64, mounted at each non-conductive spacer 48 so as to be electrically connected to conductive ring 62 associated with each spacer 48. Preferably, each ring 62 is contained within each non-conductive spacer 48. Rings 62 are in turn electrically connected to jumper cable 58, providing the connection between jumper cable 58 and anode MMO wires 64 discussed elsewhere herein. The anode assembly of FIGS. 8, 10 and 12 further may comprise a weighted cable 60 which, in this embodiment, is not electrified or carrying electrical current. The electrical current in this embodiment is carried by jumper cable 58 and anode MMO wires 64. The purpose of the weighted cable is to increase the bulk density of the anode assembly, and in particular, external sleeve 43, so that anode 16 will sink into slurry 40, facilitating the desired positioning of electrodes 16 and 18 and floats 30 as mentioned above. Without the added density, anode 16 might float on or within slurry 40 preventing the desired vertical separation between anode 16 and cathode 18.

In this embodiment, the MMO wires 64 are relatively thin strips (e.g. 3 mm in width) of metal, each having limited capacity to conduct electricity over long distances. In the preferred form of this embodiment, several measures are taken to overcome this limitation.

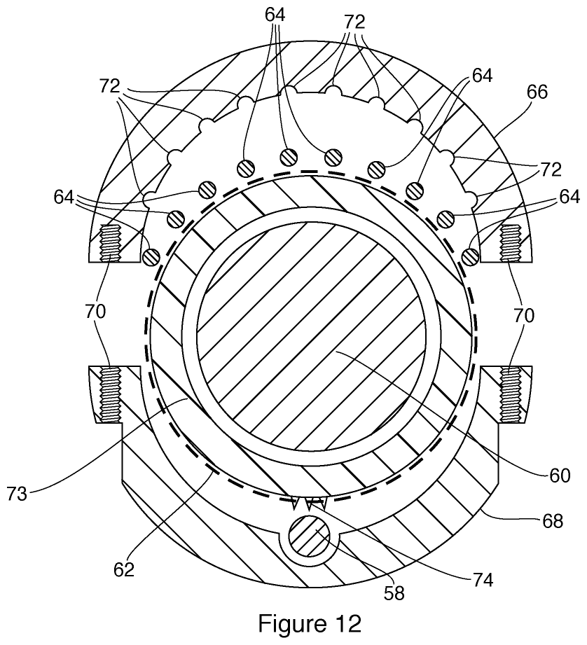

a. Each anode comprises multiple parallel MMO wires 64. As a result,
the current is distributed among multiple wires reducing the current passing through each wire and reducing the overall electrical resistance.
b. MMO wires 64 are precisely positioned such that an effectively large electrode surface area is achieved similar to what is achieved with large-diameter sacrificial anodes. This large surface area improves significantly the electric field pattern and the efficiency and uniformity of the dewatering process.
c. MMO wires 64 are connected to jumper cables 58 at each spacer 48 by means of a connecting device. In the example of FIGS. 8 and 10, these connecting devices are conducting rings 62 in cooperation with non-conductive spacers 48, though other configurations are comprehended. The connecting devices preferably have a large surface area to ensure good contact and are protected within spacer 48 (see FIG. 12) to prevent corrosion.
d. The connecting devices also preferably function to maintain the precise position of the MMO wires relative to one another so that an efficient electric field is created.

MMO materials tend to be significantly more expensive than the metals used for sacrificial electrodes. Minimizing the mass of MMO electrodes reduces the capital costs of electrode arrays. For this reason, the MMOs used for anode 16 may be thin wires or strips 64 with a large surface-area-to-mass ratio. By using multiple parallel wires 64 for an electrode, a large surface area can be created which enhances the resulting electric field. It is beneficial to have wires 64 positioned parallel to one another and evenly spaced.

Another consideration with MMO electrodes is gas production. Unlike sacrificial anodes, where some of the current passes into the solids via anode corrosion, with MMO anodes all current passes through the anodes into the surrounding material by means of electrolysis of water. As a result, MMO anodes produce greater volumes of gas, making an effective system for venting the gas to the surface that much more beneficial.

The maximum current able to be carried by thin MMO wires 64 is limited by their relatively high resistance, particularly where long electrodes 20) are required. This limitation may be overcome by using jumper cables 58 (e.g. in FIG. 8), similar to those used with sacrificial electrodes. In this case, jumper cables 58 not only mitigate the risk of local failures in MMO wires 64, but also carry most of the current due to their lower electrical resistance and reduce the risk of “burning out” MMO wires 64. If the current passing through MMO wires 64 is excessive, heating and corrosion of the metal will occur, resulting in failure of MMO wires 64. For this reason, the distance between the spacers must be balanced with the forecast current expected to be carried by MMO wires 64.

In the preferred form of this embodiment, specialized non-conductive spacers 48 are used. This preferred form of spacer is shown in FIG. 12. Non-conductive spacer 48 comprises top clamp 66 and bottom clamp 68. To assemble non-conductive spacer 48 and hold the components in place, top 64 and bottom 68 clamps are held together by bolts inserted into threaded holes 70 in top 64 and bottom 68 clamp pieces and tightened. Top clamp 66 has grooves 72 for holding MMO wires 64 against metal connecting ring 62. Likewise, lower clamp 68 has a groove to hold jumper cable 58. Metal ring 62 includes piercing connector 74 that connects ring 62 to jumper cable 58. When bolts are tightened into threaded holes 70, MMO wires 64 are held tightly against ring 62 and 10) piercing connector 74 is held tightly against jumper cable 58. Thus, jumper cable 58 is electrically connected to MMO wires 64 via piercing connector 74 and ring 62. Ring 62 is affixed to the outside of inner spacer 73. Inner spacer 73 comprises a non-conductive ring whose inner diameter is large enough for insulated weighted cable 60 to be threaded through. Ring 62, and its connections to MMO wires 64 and jumper cable 58, are insulated to prevent corrosion. The insulation may be by means of an insulating material such as epoxy, sealant or rubber gaskets, or some other mode of insulation. Non-conductive spacer 48 thus holds MMO wires 64 in position relative to one another and maintains the electrical connection between jumper cable 58 and MMO wires 64.

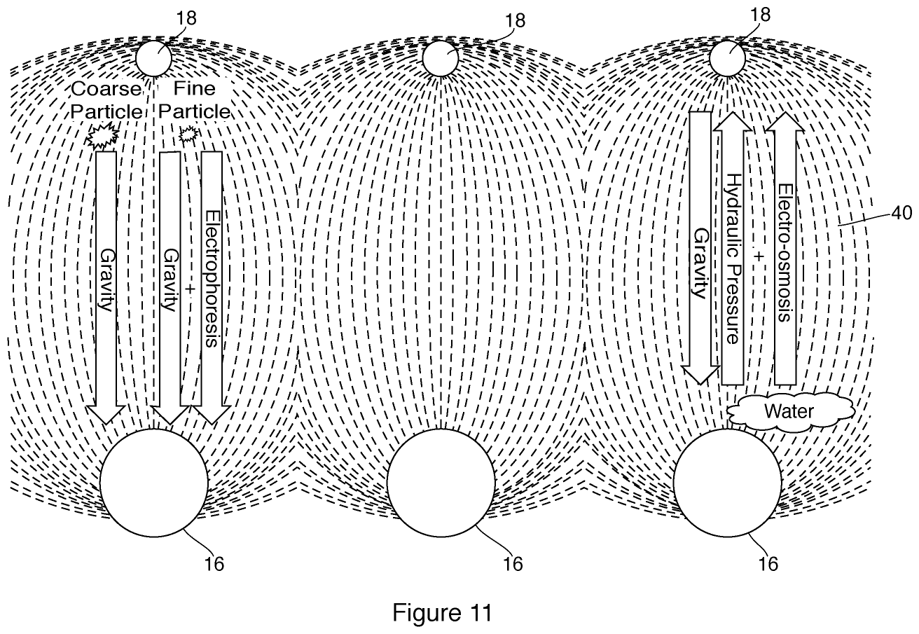

FIG. 11 shows in schematic form the forces that drive the dewatering process in the preferred embodiment. When an electric field is established between anode 16 and cathode 18, water is drawn upward toward cathode 18 by electro-osmosis and the upward hydraulic pressure gradient caused by the weight of the overlying solid particles on the pore water below.

In the absence of an electric field, finer particles tend to remain suspended for long periods due to electrostatic repulsion and Brownian motion. These finer particles are drawn down towards anode 16 by electrophoresis. This downward movement is assisted by gravity.

Several issues arise when scaling up embodiments of the present invention to a commercial scale. The first scaling issue is energy consumption. The parallel formation of the electrodes and the precise vertical and horizontal separations are useful for minimizing energy consumption. Unlike certain rectilinear electrode configurations (e.g. a cathode surrounded by three or more anodes), the parallel configuration minimizes “dead zones” between electrodes with the same charge. With many parallel, well-spaced electrodes, the electric field lines are largely straight between the anodes and the cathodes, minimizing the distance that the current and hence particles and water must travel. As well, this parallel configuration, when expanded to many electrode pairs (e.g. in excess of approximately 20 pairs on either side), results in adjacent electrodes strengthening the electric field and creating a uniform pattern of field lines whose efficiency approaches that achieved with parallel plate electrodes (i.e. perfectly straight electric field lines with no “dead zones”).

This uniform pattern maximizes energy efficiency and the dewatering rate. The voltage gradient between the electrodes is largely uniform causing a uniform dewatering rate throughout slurry 40 lying between the electrodes. The result is that the density of the dewatered slurry is reasonably uniform, and off-specification soft spots are non-existent or rare.

The vertical and horizontal separation of the electrodes may affect capital costs. Increasing the separation may reduce capital costs. On the other hand, increasing the separation may increase energy consumption (i.e. operating costs). For this reason, the vertical and horizontal separations are not fixed; instead, the separations may be customized to meet specified dewatering performance and energy consumption targets and the specific physical, chemical and electrical characteristics of slurry 40. Nonetheless, a key to minimizing energy consumption may be producing an efficient electric field pattern. It has been found that a ratio of 1:2 for the horizontal to vertical separation produces an efficient field although other ratios may be preferred for some applications.

Another means to increase energy efficiency may be to modify the applied power signature. The applied power signature varies with the chemical, electrical and physical characteristics of slurry 40 being dewatered and may be varied over the course of the dewatering process. A method of determining and applying power signatures is described in US published patent application number 2019/0241453.

Another scaling issue is power attenuation along the length of the electrodes. As current travels along the length of an electrode, the voltage in the electrode may decrease due to the electrode's resistance and current passing into slurry 40 along the length of anode 16. As a result, the current density in slurry 40 around anode 16 may also decrease along its length (i.e. as one moves along anode 16 away from the power source). Lower current density may decrease the dewatering rate of slurry 40; accordingly, the density of slurry 40 may initially decrease along anode 16 away from the power source. However, as the density of slurry 40 increases, so does its resistance reducing the local current density. The result is that the current density may decrease over time along anode 16 away from the power source with the greatest decrease occurring closest to the power source. The result is that self-correction of power attenuation may occur and the final dewatering pattern within slurry 40 is uniform along the length of anode 16.

Another issue with scaling up the system is the risk of gas buildup in the solids. As explained above, gas is produced from the electrolysis of water, hydrogen at cathode 18 and oxygen at anode 16. As the density of the solids increases, this gas may build up in the solids and not escape to the atmosphere. If the deposit is not continuously saturated (i.e. if the pores between solid particles are occupied by gas instead of water) between the electrodes, the resistance increases to the point that the current decreases significantly or stops. The result is that the dewatering process stops. The gas collection system may mitigate or eliminate this problem at scale.

A further scaling-up issue relates to the conductivity of anode 16. With sacrificial anodes, a relatively large cross-section of metal may be present so that the electrical resistance is not high even with long electrodes (i.e. greater than 1 km). With dimensionally stable anodes, the unit cost of the MMOs is higher than for sacrificial anodes. For that reason and others, minimising their mass may improve the economics. Their mass can be reduced by using multiple thin wires. However, minimising their mass increases resistance. This increase in resistance may be overcome with the use of jumper cable 58. By having regular connection points between anode 16 and jumper cable 58, the internal resistance of the thin MMO wires may be overcome.

Another issue is the vertical spacing between cathode 18 and anode16. This vertical spacing may be determined by the length of vertical tether 36 running between them. These vertical tethers may be spaced at regular intervals along the length of each electrode pair (e.g. FIG. 3).

Another issue is the horizontal spacing between cathode 18 and anode 16. This horizontal spacing may be determined by the length of horizontal tethers 32 running between cathodes 18. Horizontal tethers 32 may be spaced at regular intervals along the length of each electrode pair.

Those of ordinary skill in the art having access to the teachings herein will recognize additional variations, implementations, modifications, alterations and embodiments, all of which are within the scope of the present invention, which invention is limited only by the appended claims.

1. An apparatus for dewatering a deposit, comprising:
a plurality of cathodes and a plurality of anodes, each of the plurality of cathodes being tethered to a corresponding one of the plurality of anodes;
a plurality of positioning floats vertically tethered to at least one of the plurality of cathodes and the plurality of anodes, the plurality of positioning floats being selectively inflatable and deflatable, when the plurality of cathodes and the plurality of anodes are deployed in the deposit, to adjust the vertical positions of the plurality of cathodes and the plurality of anodes within the deposit.

2. An apparatus as claimed in claim 1, wherein each of the plurality of cathodes is vertically tethered to a corresponding one of the plurality of anodes, and wherein the plurality of positioning floats is vertically tethered to the plurality of cathodes, such that in the deposit the plurality of cathodes is suspended from the plurality of positioning floats and the plurality of anodes is suspended from the plurality of cathodes.

3. An apparatus as claimed in claim 1, further comprising at least one solar panel adapted to float on the deposit, the at least one solar panel being electrically connected to the plurality of cathodes and the plurality of anodes.

4. An apparatus as claimed in claim 3, wherein the solar panels include a control system for distributing power among multiple parallel electrode assemblies.

5. A method of adjusting the position of the apparatus of claim 2, wherein the deposit comprises slurry and a water cap overlaying the slurry, wherein a border between the water cap and slurry defines a mudline, the method comprising the step of, when the plurality of cathodes is positioned above the mudline, deflating the plurality of floats until the plurality of floats are positioned at the mudline, with the plurality of cathodes positioned at a first cathode position below the mudline and the plurality of anodes positioned in the slurry below the first cathode position.

6. A method as claimed in claim 5, wherein the method further comprises the step of inflating the plurality of floats to cause the plurality of cathodes to move upward from the first cathode position to a second cathode position that is below the mudline.

7. A method as claimed in claim 6, wherein the method further comprises the step of inflating the plurality of floats to cause the plurality of cathodes to move upward from the first cathode position to a cathode position that is above the mudline.

8. A method as claimed in claim 6, wherein the method further comprises the step of inflating the plurality of floats to cause the plurality of cathodes to move upward from the second cathode position to a cathode position that is above the mudline.

9. An apparatus as claimed in claim 1, the plurality of cathodes comprising multiple sets of cathodes, the apparatus further comprising a plurality of horizontal tethers, each of said horizontal tethers connecting one of said sets of cathodes to another of said sets of cathodes, wherein a horizontal position of the plurality of cathodes and the plurality of anodes may be adjusted by applying tension to the plurality of horizontal tethers when the plurality of cathodes and the plurality of anodes are deployed in the deposit.

10. An apparatus as claimed in claim 9, wherein each of the plurality of horizontal tethers is coupled to at least one tensioning apparatus for applying tension to the plurality of horizontal tethers.

11. An electrode assembly to be deployed in a deposit of slurry to be dewatered, the assembly comprising:
at least two electrodes for passing direct electric current through a portion of the deposit;
at least one external sleeve surrounding at least one corresponding electrode, and being spaced therefrom, for admitting water from the slurry into a space between the external sleeve and the electrode, and for trapping gas generated by the electrochemical reactions at the electrode, the external sleeve further comprising at least one gas vent for venting the gas out of the sleeve and out of the portion of the deposit.

12. An electrode assembly as claimed in claim 11, wherein the at least one corresponding electrode is a cathode and wherein the at least one corresponding electrode is an anode.

13. An electrode assembly as claimed in claim 11, wherein the external sleeve comprises an outer water-permeable geotextile membrane and an underlying support structure comprising non-conducting mesh tubing positioned between the geotextile membrane and the electrode.

14. An electrode assembly as claimed in claim 10, the electrode assembly further comprising at least one non-conductive spacer for spacing the external sleeve from the electrode to provide space for the liquid at the electrode.

15. A method of deploying a set of electrodes in a deposit for the purpose of dewatering the deposit, wherein the deposit is contained in a deposit basin, the method comprising the steps of:
providing at least a first mounting apparatus having a first electrode assembly mounted thereon, the first electrode assembly comprising a first set of cathodes and a corresponding first set of anodes connected thereto, the first electrode assembly further comprising a first plurality of positioning floats operatively connected to the electrodes of the first electrode assembly;
connecting the electrodes to at least one pulling apparatus positioned across the deposit basin from the first mounting apparatus;
deploying the electrodes by using the pulling apparatus to pull the first electrode assembly off the mounting apparatus and into the deposit.

16. A method as claimed in claim 15, wherein the mounting apparatus comprises at least one spool.

17. A method as claimed in claim 15, wherein the mounting apparatus comprises at least one rack.

18. A method as claimed in claim 15, wherein the deposit includes a water cap on top of the deposit, and wherein the electrodes are deployed by pulling the electrodes through the water cap.

19. A method as claimed in claim 15, wherein the first plurality of positioning floats is tethered to the first set of cathodes, and wherein each cathode of the first set of cathodes is tethered to a corresponding anode of the first set of anodes.

20. A method as claimed in claim 15, wherein a first plurality of floating solar panels are attached to and electrically connected to the first set of anodes and cathodes.

21. A method as claimed in claim 15, wherein the pulling apparatus comprises at least one winch.

22. A method of deploying a set of dewatering electrodes as claimed in claim 15, further comprising the steps of:
providing a mounting apparatus having a second electrode assembly mounted thereon, the second electrode assembly comprising a second set of cathodes and a corresponding second set of anodes connected thereto, the second electrode assembly further comprising a second plurality of positioning floats operatively connected to the electrodes of the second electrode assembly;
connecting the second set of electrodes to the first set of electrodes;
using the pulling apparatus to pull the second electrode assembly off the mounting element into the deposit by pulling the first electrode assembly further into the deposit.

23. The method as claimed in claim 15, wherein the first plurality of positioning floats is vertically tethered to the first set of cathodes, and wherein the first set of cathodes is vertically tethered to the first set of anodes.

24. An electrode assembly for use in a deposit dewatering apparatus deployed in a deposit, the electrode assembly comprising:
an electrode comprising at least one primary conductor;
a supplementary conductor having mutually spaced intermittent electrical connections to the at least one primary conductor along a length thereof;
insulation to electrically insulate the supplementary conductor from slurry and water in the deposit, and to insulate the supplementary conductor from the primary conductor between the intermittent electrical connections; and
at least one power source connector for connecting the at least one primary conductor to electrical power.

25. The electrode assembly as claimed in claim 24, wherein the at least one power source connector connects the supplementary conductor to electrical power.

26. An electrode assembly as claimed in claim 24, wherein the electrode is an anode.

27. An electrode assembly as claimed in claim 26, wherein the at least one primary conductor comprises a plurality of primary conductors, and wherein the supplementary conductor has intermittent electrical connections to each of the plurality of primary conductors.

28. An electrode assembly as claimed in claim 26, wherein the intermittent electrical connections are at least one metre apart from one another.

29. An electrode assembly as claimed in claim 28, wherein the intermittent electrical connections are no more than five metres apart from one another.

30. An electrode assembly as claimed in claim 27, wherein the electrode assembly comprises at least one spacer for holding the plurality of primary conductors in spaced relation to one another.

31. An electrode assembly as claimed in claim 26, wherein the electrode assembly comprises at least one spacer for holding the supplementary conductor in spaced relation to the at least one primary conductor.

32. An electrode assembly as claimed in claim 26, wherein the electrode assembly comprises at least two spacers for creating the mutually spaced intermittent electrical connections.

33. An electrode assembly as claimed in claim 26, wherein the anode comprises a mixed metal oxide anode.

34. An electrode assembly as claimed in claim 33, wherein the mixed metal oxide anode comprises a titanium core coated with at least one metal oxide selected from the group consisting of Rb₂O, RuO₂, IrO₂, PtO₂.

35. An electrode assembly as claimed in claim 26, wherein the anode comprises a sacrificial anode consisting of one or more of aluminum, iron and stainless steel.

36. An electrode assembly as claimed in claim 26, wherein the plurality of 3 primary conductors comprises mixed metal oxide conductors consisting of a titanium core coated with at least one metal oxide selected from the group consisting of Rb₂O, RuO₂, IrO₂, PtO₂.

37. An electrode assembly as claimed in claim 27, wherein the plurality of primary conductors comprises sacrificial conductors consisting one or more of aluminum, iron and stainless steel.

38. An apparatus for dewatering a deposit, the apparatus comprising:
an electrode assembly, including anodes and cathodes, for dewatering a deposit by passing electrical current to the deposit;
a least one solar panel for powering the electrode assembly and for floating on the deposit, the at least one solar panel being electrically connected to the anodes and cathodes.

39. The apparatus as claimed in claim 38, the at least one solar panel comprising a control system for distributing and regulating electrical power to the electrode assembly.
